(19) United States
(12) Patent Application Publication
(10) Pub. No.: US 2024/0320486 A1
(43) Pub. Date: Sep. 26, 2024

(54) METHOD FOR ESTABLISHING CHARGING CAPACITY PREDICTION MODEL BASED ON METEOROLOGICAL FACTORS AND CHARGING FACILITY FAILURES, AND PREDICTION METHOD AND SYSTEM THEREOF

(71) Applicant: MING CHUAN UNIVERSITY, TAIPEI (TW)

(72) Inventor: DAVID CHUNHU LI, TAOYUAN COUNTY (TW)

(21) Appl. No.: 18/347,095

(22) Filed: Jul. 5, 2023

(30) Foreign Application Priority Data
Mar. 22, 2023 (TW) 112110753

(51) Int. Cl. G06N 3/08; G06N 5/022; G06N 7/02

(52) U.S. Cl. CPC G06N 3/08; G06N 5/022; G06N 7/02

(57) ABSTRACT

Disclosed are a method of establishing a charging capacity prediction model based on meteorological factors and charging facility failures and its prediction method and system. The method includes: receiving charging capacity data of a charging facility and meteorological data of its location; extracting the number of random failures based on time from the charging capacity data, and obtaining the probability of failure from the probability mass function; performing a correlation test of the meteorological data with the charging capacity in the charging capacity data to obtain at least one feature factor; decomposing the time series of the charging data, and transforming to obtain the time series of charging data based on the time domain after noise reduction; and establishing a prediction model, using the probability values and feature factors as reference features, and using the charging time series data as a predictive target to train the prediction model.

### BACKGROUND

### Technical Field

The present disclosure relates to a method for establishing a charging capacity prediction model based on meteorological factors and charging facility failures, as well as its prediction method and system, and more particularly to a predictive model that utilizes charging data and meteorological data of charging facilities to accurately forecast the demand for electric vehicle charging, thereby facilitating the planning, management, and layout of charging infrastructure.

### Description of Related Art

In recent years, the global demand for energy resources such as oil and natural gas has been tight, and the energy problem has led to inflation, prompting governments and companies around the world to actively expand and layout new energy industries. Major countries including European countries, the United States and Japan have successively announced their target schedules for banning the sale of gasoline vehicles. Under the global trend of promoting green energy and reducing carbon emission, electric vehicles are regarded as the most important new energy automobile industry. European Union (EU) countries have developed individual national policies to encourage car manufacturers to produce electric cars and develop charging infrastructures. The development of the electric vehicle industry chain is also included as a key focus in accelerating industrial technology innovation and transformation in mainland China, and both central and local governments are actively promoting policies to stimulate the demand for electric vehicles. The National Development Council of Taiwan announced on Mar. 30, 2022 the “2050 Net-Zero Emissions Path and Strategy Overview”, which includes plans to fully electrify large vehicles by 2030, and set sales targets of 30% and 60% for electric four-wheel small passenger cars in 2030 and 2035, respectively. After 2040, only battery electric vehicles (BEV) will be sold, and as the market penetration rate of electric vehicles increases year by year, the charging capacity of electric vehicles will also increase. The demand for electric vehicle charging is closely related to the development of electric vehicle charging infrastructure and the planning of the country's power supply system.

However, electric vehicle charging stations often become unusable due to technical failures or human factors, which ultimately affect the behavior of electric vehicle owners and their charging needs. In addition, the world is also facing the impact of extreme weather conditions, and global warming leads to heatwaves, droughts, floods, wildfires, water scarcity, cold snaps, etc., and the intensity and frequency of occurrence of these extreme weather events are increasingly severe and are seriously affecting the society, economy, and people's lives. Therefore, how to accurately forecast the demand for electric vehicle charging in an environment with frequently occurring malfunctions in infrastructure and extreme weather conditions is of great importance to governmental and corporate deployments of the development of electric vehicle charging infrastructures and power systems.

In recent years, research in the field of electric vehicles has become a hot topic, and the prediction of long-term or short-term charging demands using various technologies is one of the important research topics. In an existing study, four deep learning methods for short-term electric vehicle charging load were compared, mainly predicting the demand for electric vehicle charging from the perspective of charging piles and analysing and comparing the deep neural network (DNN), recurrent neural network (RNN), long short-term memory (LSTM), and gated recurrent unit (GRU) to predict the charging load of electric vehicle charging piles within 24 hours, the main researches uses the normalized root mean square error (NRMSE) and normalized mean absolute error (NMAE) as performance indicators for evaluating the accuracy of prediction of the deep learning model, and the research results show that GRU performs best in predicting the load and demand for short-term electric vehicle charging in the next hour.

In another study, the framework of a model-based multi-channel convolutional neural network and temporal convolutional network (MCCNN-TCN) was proposed to predict electric vehicle charging load within seven days. The MCCNN-TCN framework consists of two parts, MCCNN and TCN. MCCNN is a multi-channel convolutional neural network designed to extract the characteristics of electric vehicle charging load fluctuations at various time intervals, and TCN is a temporal convolutional neural network designed to establish a time series between the characteristics of electric vehicle charging load fluctuations and the predicted charging load. The study also uses a backpropagation neural network (BP) to map meteorological data in the areas where charging stations are located into a high-latitude vector, and then combines the output vector of BP with the output vector of the TCN network. Its experimental results show that compared to ANN, LSTM, CNN-LSTM, and TCN models, the model based on MCCNN-TCN framework has the best performance in predicting electric vehicle charging load, with a maximum reduction of the mean absolute percentage error by 27.32%.

In a related art, a reinforced learning-assisted deep learning framework has been disclosed to address the issue of predicting electric vehicle charging loads, and its framework converts the charging power data of electric vehicle charging stations into a time series format and trains a long short-term memory (LSTM) deep learning model to obtain point predictions of charging power. To overcome the uncertainty of charging behavior in electric vehicles, this disclosure uses a Markov decision process (MDP) and proximal policy optimization (PPO) algorithm to model the changes in component states of an LSTM model and designs an Adaptive Exploration Proximal Policy Optimization (AePPO) algorithm based on reinforcement learning, aiming to improve the balance between exploration and learning during model training of PPO algorithm with adaptivity, thus avoiding local optima. It primarily uses the ACN dataset to verify the performance of the proposed framework model, and adopts CRPS, Winkler, and Pinball as experimental performance analysis indicators, compared with existing LSTM-PPO, GBQR, QR, QRSVM models to verify the superior effectiveness and excellent performance of the proposed LSTM-AePPO framework.

Related researches also propose a hybrid model for predicting the demand for electric vehicle charging, which incorporates both traditional time series prediction models and machine learning techniques. In traditional time series prediction models, the research team has utilized dynamic harmonic regression, seasonality and trend decomposition, and Bayesian structural time series techniques. Random forest and extreme gradient boosting prediction models are mainly used in machine learning prediction models. In addition, a stacking ensemble learning architecture is designed to address the issue of poor prediction performance of traditional machine learning models. Based on the newly designed framework and the use of electric vehicle charging dataset collected from the Ministry of Environment of Korea, novel random forest and extreme gradient boosting prediction models (Stack.XGBoost and Stack.GLM) were trained and compared against traditional time series statistical models (DHR, STLM, and BSTS) for prediction performance, and experimental results show that this dual-type framework design can effectively improve the accuracy of prediction.

Van Kriekinge also proposed an enhanced deep learning prediction system framework to predict the demand for electric vehicle charging in the next day. The framework integrates temperature and rainfall factors, and includes time-related feature factors generated by data processing technique, and uses data engineering to generate aggregated datasets for the primitive data of electric vehicle charging capacity, and has trained three enhanced Long Short Term Memory (LSTM) prediction models, respectively: LSTM-B, LSTM-C and LSTM-W based on the designed framework. The LSTM-B model uses only the most primitive electric vehicle charging characteristics; the LSTM-C model uses electric vehicle charging characteristics as well as time-related factors (e.g., quarters, dates, binary workdays and holidays); and the LSTM-W model uses only the electric vehicle charging characteristics; and the LSTM-W model, time-related factors, and temperature and rainfall characteristics. Van Kriekinge's framework used the charging data of a small electric vehicle fleet in a hospital as the dataset for the training model, and then compared the accuracy of the three models in forecasting the demand for electric vehicle charging in the next day. Experimental results show that the LSTM-W model is effective in reducing the MAE error of 28.8% and the RMSE prediction error of 19.22%.

In another research, five machine learning and deep learning models for predicting electric vehicle charging are also compared, namely, trigonometric exponential smoothing state space (ARMA), trend and seasonality (TBATS), autoregressive integrated moving average based on past values and exogenous variables (ARIMA), artificial neural network (ANN), and long and short-term memory (LSTM). This research focuses on charging data for all electric vehicles in Korea from 2018 to 2019 collected by the Ministry of Environment of Korea and analyzes historical data on electric vehicle charging at macro and micro geographic scales, including country size, city size, and single charging station size. Experimental results validate the importance of historical charging data in predicting future charging demand; researchers can deepen the analysis from historical data, and process and transform these data to generate more diverse data to increase the polymorphic nature of the dataset for training models.

To cope with the new challenges that the rapid growth of electric vehicles may bring to the grid load status, Dabbaghjamanesh et al. proposed a technique based on enhanced learning to predict the charging load of electric vehicle charging stations, studied the three main charging behaviors of the plug-in hybrid electric vehicle (PHEV) including intelligent, uncoordinated and coordinated behaviors in depth, and proposed models to describe the charging loads of PHEVs generated by each of the three charging behaviors, and then use Q-Learning reinforcement learning techniques to train models for predicting PHEV loads, and verify the effectiveness and advantages of their techniques for predicting electric vehicle charging loads.

However, existing technologies and studies are still lacking in considering the important factors of the failure of electric vehicle charging stations, as well as the lack of the data about the elimination of charging volume time series noises, and the lack of in-depth analysis of the impact of multiple climate data on charging volume, and very few current studies have been able to propose a complete framework of prediction systems, and data pipeline designs and methods of data science

In view of the aforementioned deficiencies of the related art, the inventors of this disclosure have further studied the correlation between the demand for electric vehicle charging and the climate, conducted extensive research and experiment, and developed the modelling method and its prediction method and system to overcome the deficiencies of the related art.

### SUMMARY

Therefore, it is a primary objective of the present disclosure to overcome the aforementioned problems and achieve the aforementioned objectives by providing a method of establishing a charging capacity prediction model based on meteorological factors and charging facility failures, and the method is loaded by a device to carry out the steps of: receiving charging capacity data of a charging facility and meteorological data at where the charging facility is located; extracting a number of random failures based on time from the charging capacity data, and calculating a probability value of the occurrence of a failure by a probability mass function (PMF); performing a correlation test of the meteorological data and the charging capacity in the charging capacity data to obtain at least one feature factor; decomposing a time series of the charging capacity data, and performing a conversion to obtain time domain-based charging capacity time series data after reducing noise; and establishing a prediction model, using the probability value and feature factor as reference features, and using the charging capacity time series data as a predictive target to train the prediction model.

The method of establishing a charging capacity prediction model based on meteorological factors and charging facility failures further includes the steps of pre-processing the received charging capacity data and meteorological data, and extracting effective data by an exploratory data analysis.

In the method of establishing a charging capacity prediction model based on meteorological factors and charging facility failures, the pre-processing includes the step of cleaning at least one selected from the group consisting of an abnormal value and a missing value.

In the method of establishing a charging capacity prediction model based on meteorological factors and charging facility failures, the correlation test is at least one of the Pearson's correlation test and the Spearman's rank correlation test.

In the method of establishing a charging capacity prediction model based on meteorological factors and charging facility failures, the feature factor is a cumulative rainfall based on the charging capacity data.

In the method of establishing a charging capacity prediction model based on meteorological factors and charging facility failures, a threshold is set for noise reduction after the time series of the charging capacity data is decomposed by Fast Fourier Transform (FFT), and Inverse Fourier Transform of the time series is performed after the noise reduction, to obtain time domain-based charging capacity time series data.

In the method of establishing a charging capacity prediction model based on meteorological factors and charging facility failures, the prediction model is a multilayer perception model (MLP), a convolutional neural network (CNN), a recurrent neural network (RNN), a long short-term memory (LSTM), or a self-attention based transformer model.

This disclosure also provides a charging capacity prediction method based on meteorological factors and charging facility failures, and the method further includes the step of predicting a future capacity of the charging facility by the prediction model, in addition to the steps of the aforementioned method of establishing a charging capacity prediction model based on meteorological factors and charging facility failures.

This disclosure further provides a charging capacity prediction system based on meteorological factors and charging facility failures, and the system includes a processor and at least one storage device, and the storage device stores a system framework that includes the aforementioned method of establishing a charging capacity prediction model based on meteorological factors and charging facility failures, and the processor is executed to operate the system framework.

From the above description and design, it is apparent that this disclosure has the following advantages and functions.

1. This disclosure is based on receiving charging capacity data of the charging facility and the meteorological data of its location, and then performing its data analysis statistics, queuing theory, correlation analysis, and Fourier Transform theory in order to establish the prediction model. The deep learning system framework can improve the accuracy of predicting the demand for electric vehicle charging in a complex environment by means of prediction model, thereby helping the layout, management and planning of charging facilities at the time of construction. This system framework is suitable for the development of energy policy to facilitate the deployment of electric vehicle charging network, so as to enhance the popularity of electric vehicles while achieving the effects of energy saving and environmental protection.

### BRIEF DESCRIPTION OF THE DRAWINGS

FIG. 1 is a flow chart of this disclosure;

FIG. 2 is a system block diagram of this disclosure;

FIG. 3 shows the results of the data analysis of the total daily demand for electric vehicle charging in Palo Alto from July 2011 to December 2020;

FIG. 4 shows the results of the analysis of the daily maximum, daily minimum, and daily average charging capacity of electric vehicles in Palo Alto from 2012 to 2020;

FIG. 5a shows the PMF curves of the corresponding probability of electric vehicle charging pile failure;

FIG. 5b shows the CDF curve of the corresponding probability of electric vehicle charging pile failure;

FIG. 6a shows the daily maximum temperature change in Palo Alto from July 2011 to December 2020;

FIG. 6b shows the daily maximum humidity change in Palo Alto from July 2011 to December 2020;

FIG. 6c shows the daily maximum sea-level pressure change in Palo Alto from July 2011 to December 2020. FIG. 6d shows the daily cumulative rainfall change in Palo Alto from July 2011 to December 2020.

FIG. 7 is a heat map showing the results of the Spearman's rank correlation between certain meteorological parametric factors in Palo Alto and the local electric vehicle charging capacity;

FIG. 8 shows the Fourier-transform spectrum of the total daily charging capacity of electric vehicles in Palo Alto from July 2011 to December 2020;

FIG. 9 shows the time series data of electric vehicle charging capacity in Palo Alto after filtering noise when the threshold is set to 0.1;

FIG. 10 shows the comparison of the p-values corresponding to the time series noise when setting different thresholds to eliminate the Fourier transformation of the electric vehicle charging capacity in Palo Alto;

FIG. 11 shows the FFT time series data plot of daily electric vehicle charging capacity in Palo Alto from April 16 to Jul. 31, 2014 after filtering noise and when the threshold is set to 0.003;

FIG. 12 shows the time series data plot of daily demand for electric vehicle charging in Palo Alto from July 2011 to December 2020, which is obtained by inverse Fourier transformation and when the threshold is set to 0.003;

FIG. 13 shows the comparison of models of predicting the 10-day demand for electric vehicle charging in accordance with this disclosure; and

FIG. 14 shows the comparison of models of predicting the 30-day demand for electric vehicle charging in accordance with this disclosure.

### DESCRIPTION OF THE EMBODIMENTS

The technical characteristics of the present disclosure will become apparent in the following detailed description of the preferred embodiment with reference to the accompanying drawings.

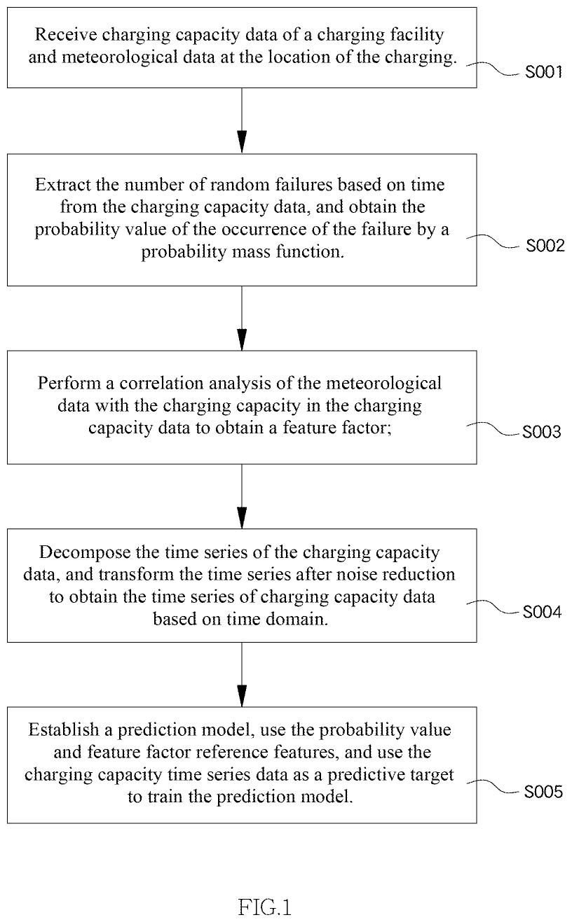

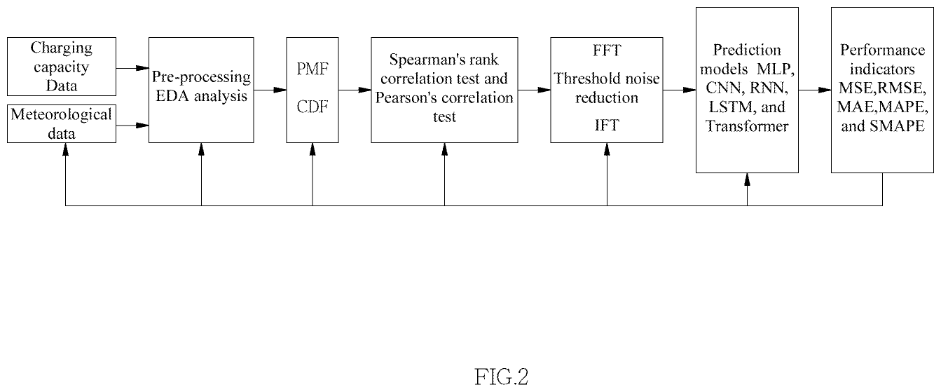

With reference to FIGS. 1 and 2 for a method of establishing a charging capacity prediction model based on meteorological factors and charging facility failures in accordance with this disclosure, the method is loaded by a device to execute a procedure, which includes the following steps:

S001: Receive charging capacity data of a charging facility and meteorological data at where the charging facility is located;

In this embodiment, the charging capacity data of the electric vehicle charging station facility (such as charging pile) in Palo Alto, Santa Clara County, California, U.S.A. from July 2011 to December 2022 were collected, but this disclosure is not limited to this embodiment only. The charging capacity data include 259415 records of the electric vehicle charging transaction data and 18 data fields related to the electric vehicle charging behavior. Since the collected data are primitive data, therefore the primitive data are pre-processed. The pre-processing includes cleaning at least one selected from an abnormal value and a missing value, and then its effective data are extracted by the Exploratory Data Analysis (EDA) to obtain valuable data and analyse results;

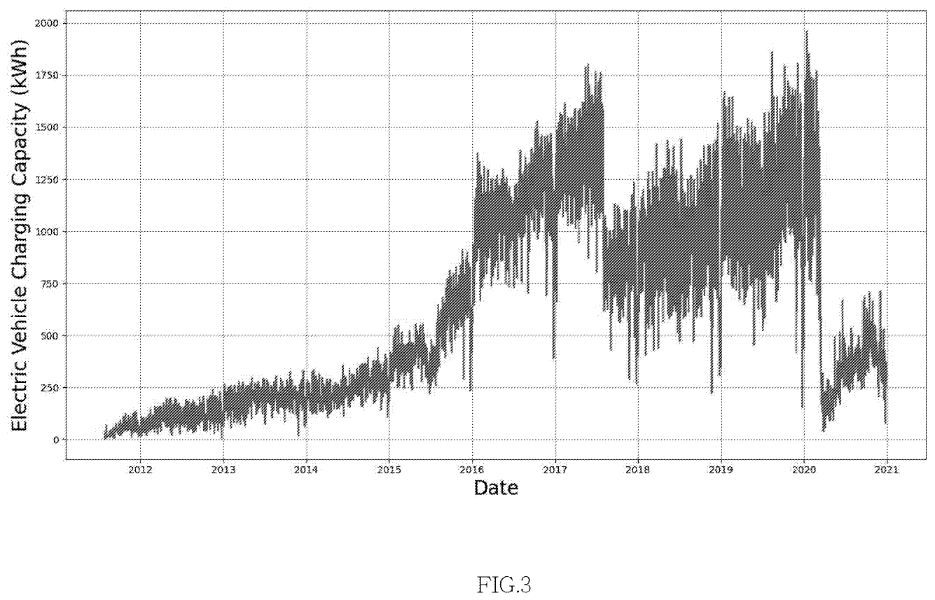

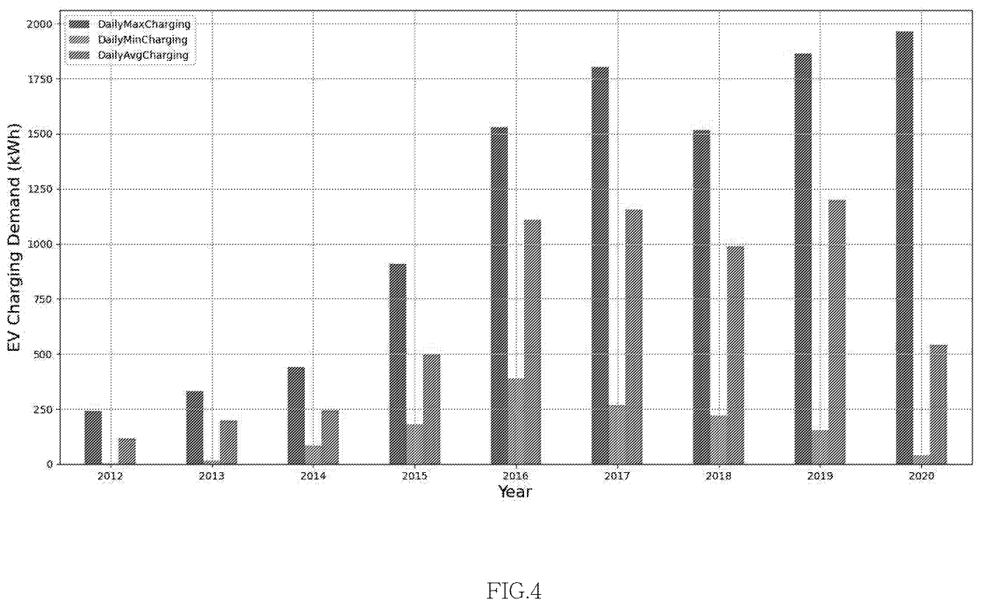

With reference to FIG. 3 for the data analysis results of the total daily demand for electric vehicle charging in Palo Alto from July 2011 to December 2020, the total daily charging capacity of electric vehicles shows a gradual increase and reaches a historical peak of 1962.229 kWh on Jan. 15, 2020.

Table 1 below shows the total demand for electric vehicle charging in Palo Alto for each of the years 2012 to 2020 and 9 years in total:

TABLE 1

| | | | | | Standard |
|---|---|---|---|---|---|
| | | Daily maximum | Daily minimum | Daily average | deviation of |
| | Charging | charging | charging | charging | daily charging |
| Year | capacity | capacity | capacity | capacity | capacity |
| 2012 | 42,974.119 | 238.752 | 3.576 | 117.416 | 46.647 |
| 2013 | 71,901.404 | 330.250 | 17.181 | 196.990 | 50.434 |
| 2014 | 88,389.094 | 440.864 | 84.165 | 242.162 | 61.532 |
| 2015 | 181.465.351 | 908.235 | 180.642 | 497.165 | 155.505 |
| 2016 | 405,569.120 | 1,528.236 | 388.030 | 1,108.112 | 187.912 |
| 2017 | 422,255.286 | 1,803.766 | 267.214 | 1,156.864 | 339.368 |
| 2018 | 360,270.736 | 1,516.062 | 220.001 | 987.043 | 249.761 |
| 2019 | 437.696.059 | 1,862.674 | 152.441 | 1,199.167 | 295.713 |
| 2020 | 197,624.376 | 1,962.229 | 38.283 | 539.957 | 444.865 |
| 2012- | 2,208,145.545 | 1,962.229 | 3.576 | 671.577 | 482.888 |
| 2022 | | | | | |

FIG. 4 shows the data analysis of daily maximum charging capacity, daily minimum charging capacity, and daily average charging capacity of electric vehicles in Palo Alto from 2012 to 2020. As shown in Table 1 above and FIG. 4, the total electric vehicle charging capacity in Palo Alto from 2012 to 2020 reaches 2208145 kWh, and the maximum and average daily electric vehicle charging capacities also show an increasing trend year by year; especially from 2015 to 2016, the daily maximum charging demand increased significantly, indicating a significant increase in the penetration rate of electric vehicles in Palo Alto from 2015 to 2016.

S002: The charging pile may not work properly due to the aging of hardware parts, errors in the software itself causing abnormal function, or human factors, environmental factors, etc., and the failure of electric vehicle charging stations or charging piles will affect the car owner's behavior of charging their electric vehicles, and will also have an impact on the overall charging capacity. Therefore, this disclosure extracts the number of random failures based on time from the charging capacity data, obtains the probability value of the occurrence of the failure by a probability mass function (PMF), assumes the process of having number of failures of the electric vehicle charging pile occurred is a random process, which can be denoted by {N(t), t≥0}, where N(t) denotes total number of failures of the electric vehicle charging pile at time t, and N(0)=0. We assume that the process of the number of failures of the electric vehicle charging pile meets the following three characteristics:
1. The probability of a charging pile failure occurred between the time intervals t and t+Δt is equal to λΔt+o(Δt), where λ is a constant with N(t), Δt is time increment, and o(Δt) is the time increment that becomes negligible as Δt approaches to zero, when compared to Δt.
2. The probability of more than one charging pile failure occurred between t and t+Δt is equal to o(Δt).
3. The number of charging pile failures of occurring at non-overlapping time interval is statistically independent, that is, the process of having the failure has independent increments.

Therefore, this embodiment describes the process of the vehicle charging pile failure as a Poisson process, which conforms to the Poisson probability distribution; and the probability Pₙ(t) of having n times of electric vehicle charging pile failures occurred in the time internal t is calculated by the Mathematical Equation 1 below, where λ is a positive number of a historical average.

$${P}_{n} ( t ) = \frac{{( λ t )}^{n}}{n !} {e}^{- λ t} \qquad [ Mathematical Equation 1 ]$$

From the Mathematical Equation 1, we can conclude that the number of electric vehicle charging pile failures is a discrete random variable with Poisson distribution, and the events of charging pile failures are independent of each other and independent of time, and its probability mass function is shown in the Mathematical Equation 2 below:

$$p ( λ , k ) = \frac{{λ}^{k} {e}^{- λ}}{k !} \qquad [ Mathematical Equation 2 ]$$

where, λ is a positive number of historical average, k is the number of failures;

The Cumulative Distribution Function (CDF) of the Poisson distribution of the charging pile failure is shown in the Mathematical Equation 3 below.

$$F ( λ , k ) = {\sum }_{i = 0}^{k} \frac{{λ}^{i} {e}^{- λ}}{i !} \qquad [ Mathematical Equation 3 ]$$

The probability corresponding to the number of electric vehicle charging pile failures can be calculated by Mathematical Equation 2 based on Poisson probability mass function. With reference to Table 2 for a probability comparison table of the number of failures within a year based on the PMF calculation of electric vehicle charging piles, the probability of 2 and 3 charging pile failures in the next year is the highest, 22.404%; while the probability of 1 failure is 14.936%, and the probability of more than 13 failures is 0.

TABLE 2

| No. of failures per year | Probability (%) |
|---|---|
| 0 | 4.979 |
| 1 | 14.936 |
| 2 | 22.404 |
| 3 | 22.404 |
| 4 | 16.803 |
| 5 | 10.082 |
| 6 | 5.041 |
| 7 | 2.16 |
| 8 | 0.81 |
| 9 | 0.27 |
| 10 | 0.081 |
| 11 | 0.022 |
| 12 | 0.006 |
| 13 | 0.001 |
| 14 | 0 |
| 15 | 0 |
| 16 | 0 |
| 17 | 0 |
| 18 | 0 |
| 19 | 0 |

With reference to Table 3 for a probability comparison table of the maximum number of failures within a year based on the CDF calculation of electric vehicle charging piles, the probability of a maximum of 2 charging pile failures within a year is 19.915%, the probability of a maximum of 3 failures is 42.319%, and the probability of no failure is 4.979%.

TABLE 3

| No. of failures per year | Probability (%) |
|---|---|
| 0 | 4.979 |
| 1 | 19.915 |
| 2 | 42.319 |
| 3 | 64.723 |
| 4 | 81.526 |
| 5 | 91.608 |
| 6 | 96.649 |
| 7 | 98.81 |
| 8 | 99.62 |
| 9 | 99.89 |
| 10 | 99.971 |
| 11 | 99.993 |
| 12 | 99.998 |
| 13 | 100 |
| 14 | 100 |
| 15 | 100 |
| 16 | 100 |
| 17 | 100 |
| 18 | 100 |
| 19 | 100 |

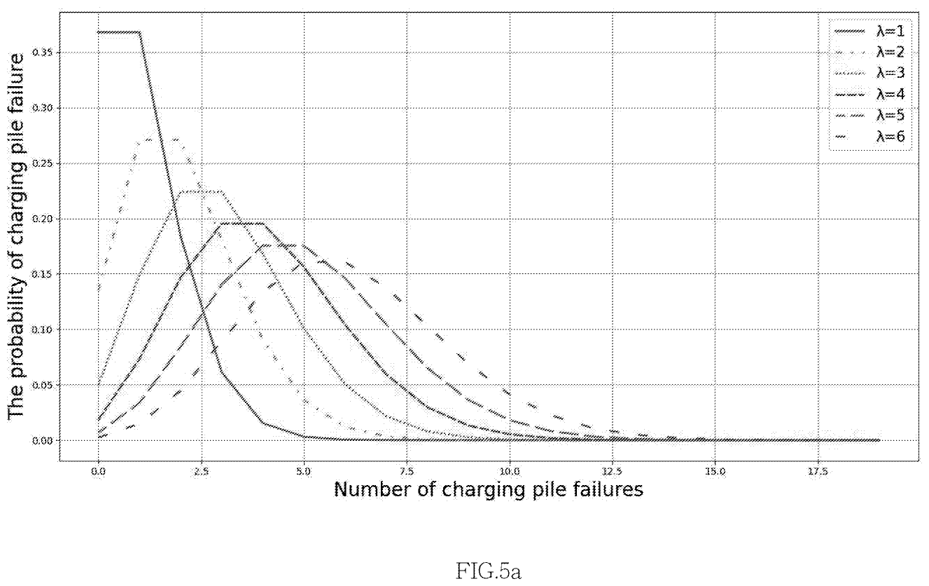

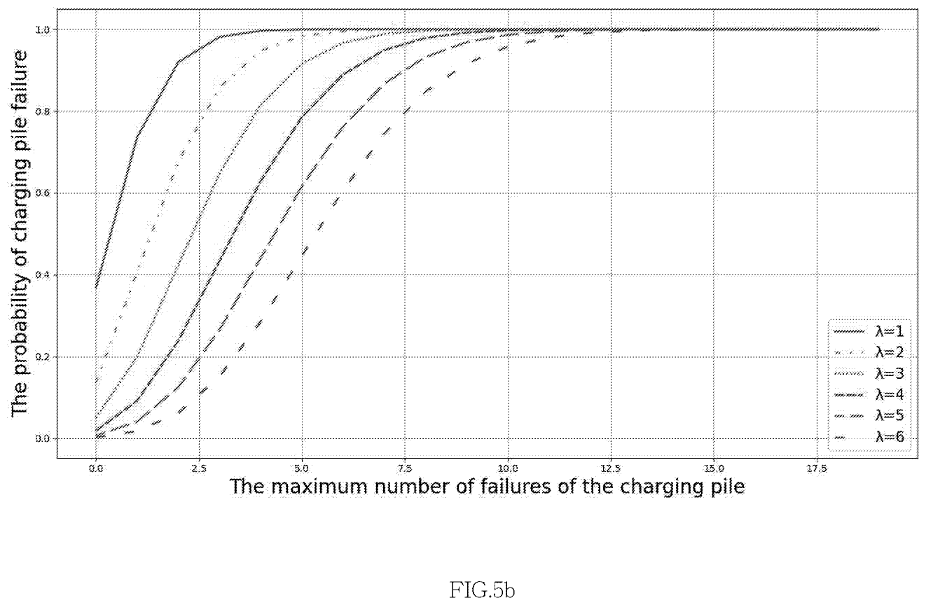

FIGS. 5a and 5b are PMF and CDF curves of the corresponding probability of a failure occurring in an electric vehicle charging pile, which show the change of the probability of the number of charging pile failures and the probability of the maximum number of the charging pile failures for different values of λ. It can be observed from FIG. 5 that when λ=1, the curves of PMF and CDF change more steeply, which means that the number of charging pile failures occurring 0 to 2.5 times within a year, and the maximum number of failures occurring 0 and 2.5 times within a year has the most significant change in probability. In addition, the user of the model can calculate the probability of an electric vehicle charging pile failure in any time interval based on actual needs, and use the calculated probability value as a feature factor of the dataset for training the prediction model.

S003: Perform a correlation analysis of the meteorological data with the charging capacity in the charging capacity data to obtain at least one feature factor;

To study the impact of an increasingly extreme climate on the demand for electric vehicle charging, historical meteorological data of Palo Alto from July 2011 to December 2020 were collected from Weather Underground, a U.S. meteorological website, and a correlation analysis was conducted using statistical models in an embodiment of this disclosure.

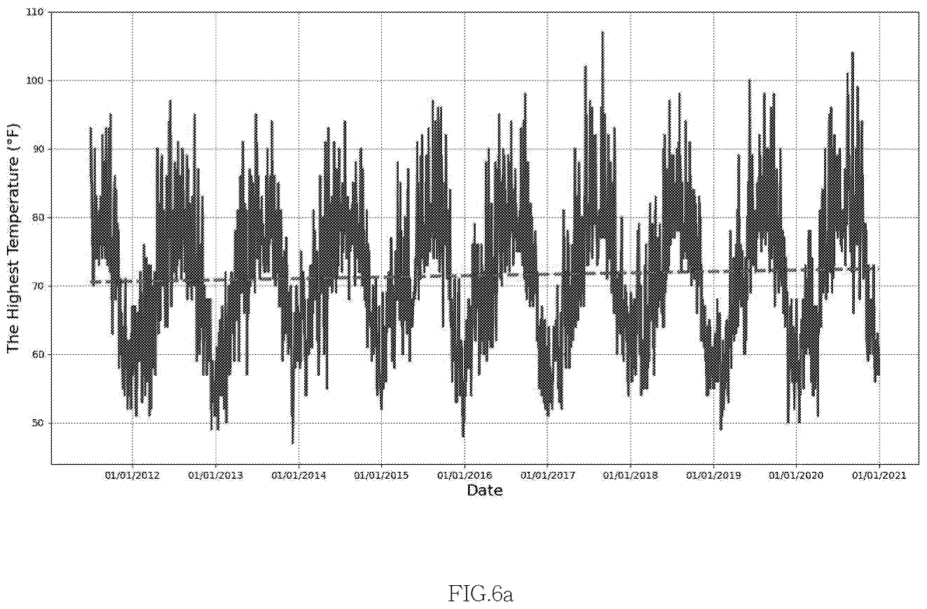

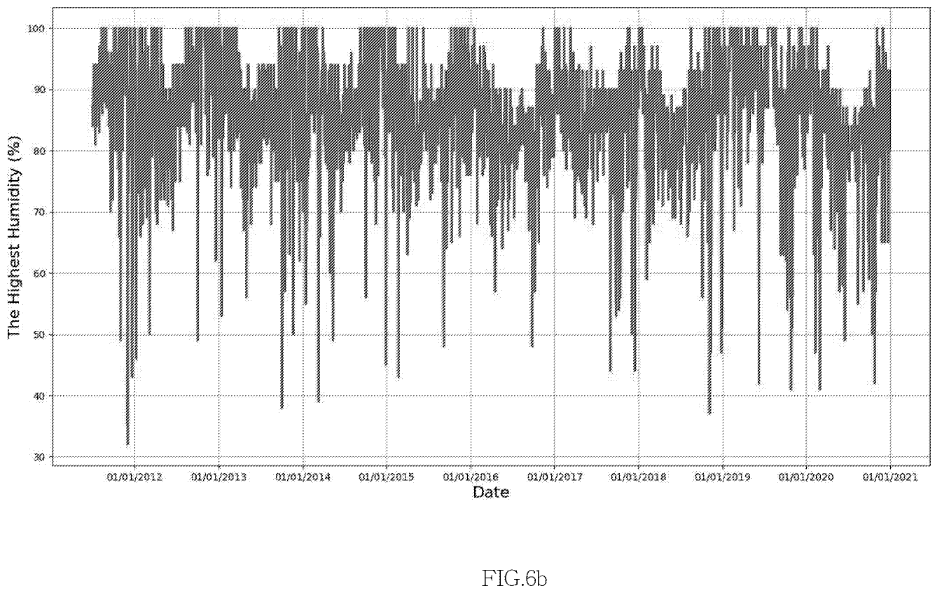

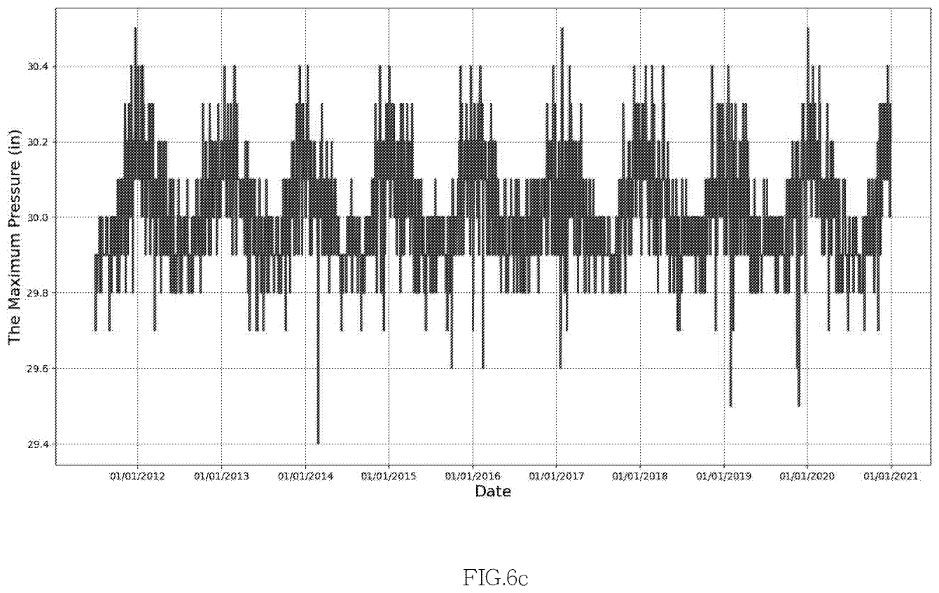

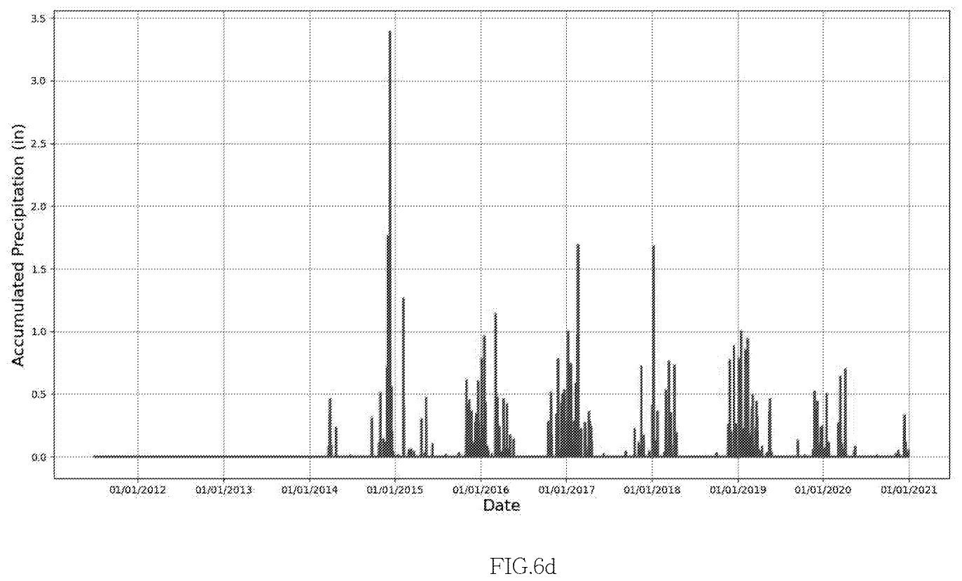

With reference to FIGS. 6a to 6d for the climate change maps of Palo Alto from July 2011 to December 2020, including daily maximum temperature, daily maximum humidity, daily maximum sea level pressure and daily cumulative rainfall, the trend line in FIG. 6a shows that the daily maximum temperature in Palo Alto is gradually increasing due to global warming, and some days are unusually hot, for example, the maximum temperature reached 107 degrees Fahrenheit (41.67 degrees Celsius) on September 1 and Sep. 2, 2017. In addition, FIG. 6d shows that the accumulated rainfall on Dec. 12, 2014 was 3.39 inches (86.784 mm), reaching the level of rainstorm.

In this embodiment, Pearson's correlation test and Spearman's rank correlation test are used to analyze the correlation between various climate factors and the demand for electric vehicle charging. In these tests, Pearson's correlation test is an important statistical test to examine the strength of linear relationship between the matched data, and the calculation of Pearson's correlation test and the subsequent significance test p-value need to meet the assumptions of the data, including interval or ratio level, linear correlation, and bivariate variables that need to show a normal distribution, etc. If test data do not match the above assumptions, then the Spearman's rank correlation analysis will be required. The calculation of the Spearman's rank correlation coefficients and subsequent significance tests require that the data meet data assumptions, including that data are interval or ratio level or ordinal, and that the data are monotonically correlated, in which the Spearman's rank correlation coefficients do not require the assumption of normal distribution, so that it is a nonparametric statistic.

Pearson's correlation test is calculated by the Mathematical Equation 4 below:

$${r}_{xy} = \frac{( n {\sum }_{i = 1}^{n} {x}_{i} {y}_{i} - {\sum }_{i = 1}^{n} {x}_{i} {\sum }_{i = 1}^{n} {y}_{i} )}{\sqrt{n {\sum }_{i = 1}^{n} {x}_{i}^{2} - {( {\sum }_{i = 1}^{n} {x}^{i} )}^{2}} \sqrt{n {\sum }_{i = 1}^{n} {y}_{i}^{2} - {( {\sum }_{i = 1}^{n} {y}_{i} )}^{2}}} \qquad [ Mathematical Equation 4 ]$$

The Spearman's rank correlation is calculated by the Mathematical Equation 5 below:

$$ρ = \frac{{S}_{xy}}{{S}_{x} {S}_{y}} = \frac{\frac{1}{n} {\sum }_{i = 1}^{n} ( R ( {x}_{i} ) - \overline{R ( x )} ) \cdot ( R ( {y}_{i} ) - \overline{R ( y )} )}{\sqrt{( \frac{1}{n} {\sum }_{i = 1}^{n} {( R ( {x}_{i} ) - \overline{R ( x )} )}^{2} )} \cdot {( \frac{1}{n} {\sum }_{i = 1}^{n} R ( {y}_{i} ) - \overline{R ( y )} )}^{2} )} \qquad [ Mathematical Equation 5 ]$$

Where, Sₓ and S_{y} are standard deviations, S_{xy} is sample covariance, R(x) and R(y) are ranks; R̅(̅x̅)̅ and R̅(̅y̅)̅ are mean ranks, and n is sample size.

In an embodiment, the significance test of the correlation analysis of this disclosure uses p-value, which is calculated by the Mathematical Equation 6 below:

$$p value = \frac{\hat{p} - {p}_{o}}{\sqrt{\frac{{p}_{o} ( 1 - {p}_{o} )}{n}}} \qquad [ Mathematical Equation 6 ]$$

Where, \hat{p} is data sample proportion, pₒ is assumed population proportion in null hypothesis, and n is sample size.

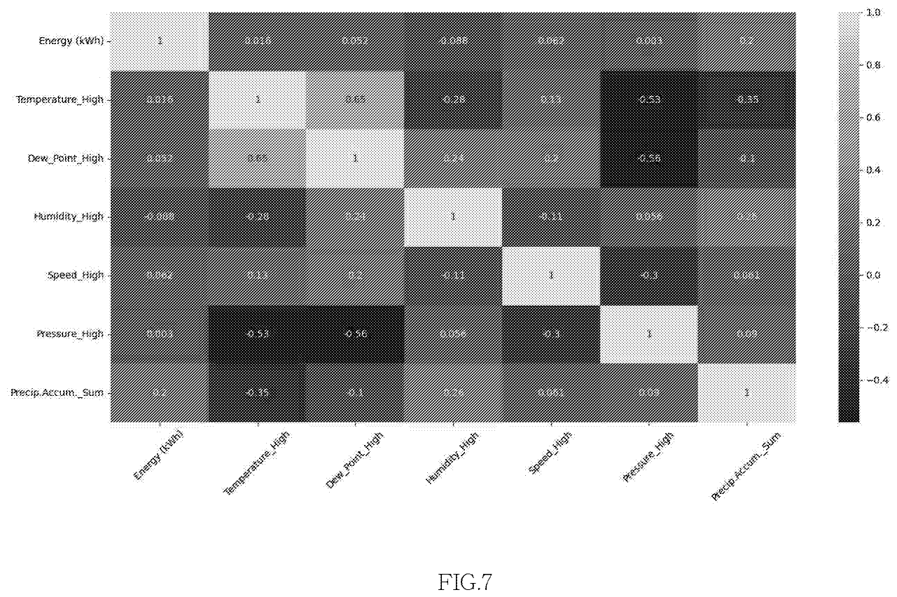

FIG. 7 is a heat map showing the results of the Spearman's rank correlation between certain meteorological parametric factors in Palo Alto and local electric vehicle charging capacity, and shows the test results of the Pearson's rank correlation between meteorological parametric factors in Palo Alto and local electric vehicle charging capacity. It is observed from the data distribution of the charging demand and various meteorological factors that the data distribution of each data feature is not a normal distribution. The test results of the Spearman's rank correlation and Pearson's correlation between the electric vehicle charging capacity and 16 meteorological features are in Table 4 below.

TABLE 4

| | | Spearman's | | | |
|---|---|---|---|---|---|
| | | rank | | Pearson's | |
| First attribute | Second attribute | correlation test | p-Value | correlation test | p-Value |
| Charging | Maximum | 0.0159 | 0.3524 | 0.0042 | 0.8055 |
| capacity | temperature | | | | |
| Charging | Average temperature | 0.0566 | 0.0009 | 0.0461 | 0.0068 |
| capacity | | | | | |
| Charging | Minimum | 0.0632 | 0.0002 | 0.0454 | 0.0077 |
| capacity | temperature | | | | |
| Charging | Maximum dew point | 0.0518 | 0.0024 | 0.06 | 0.0004 |
| capacity | | | | | |
| Charging | Average dew point | 0.0596 | 0.0005 | 0.0704 | 0.0000 |
| capacity | | | | | |
| Charging | Minimum dew point | 0.0680 | 0.0001 | 0.1335 | 0.0000 |
| capacity | | | | | |
| Charging | Maximum humidity | −0.0878 | 0.0000 | −0.0522 | 0.0022 |
| capacity | | | | | |
| Charging | Average humidity | −0.0019 | 0.9134 | 0.0067 | 0.6946 |
| capacity | | | | | |
| Charging | Minimum humidity | 0.0816 | 0.0000 | 0.0848 | 0.0000 |
| capacity | | | | | |
| Charging | Maximum wind | 0.0616 | 0.0003 | 0.0681 | 0.0001 |
| capacity | speed | | | | |
| Charging | Average wind speed | 0.1102 | 0.0000 | 0.1143 | 0.0000 |
| capacity | | | | | |
| Charging | Minimum wind | 0.0424 | 0.0128 | 0.0342 | 0.0445 |
| capacity | speed | | | | |
| Charging | Maximum pressure | 0.0030 | 0.8598 | 0.0217 | 0.2037 |
| capacity | | | | | |
| Charging | Average pressure | −0.0136 | 0.4260 | −0.0192 | 0.2591 |
| capacity | | | | | |
| Charging | Minimum pressure | −0.0065 | 0.7035 | −0.0231 | 0.1750 |
| capacity | | | | | |
| Charging | Cumulative rainfall | 0.2043 | 0.0000 | 0.1141 | 0.0000 |
| capacity | | | | | |

In FIG. 7 and Table 4, we can see that there is a monotonic correlation between electric vehicle charging capacity and cumulative rainfall in Palo Alto (Correlation: 0.2043, and p-value: 0.0000), and the demand for charging is not correlated with other meteorological factors, and thus the analysis results are consistent with the behavior pattern that rain affects people's willingness to go out and charge their electric vehicles. The meteorological factor (cumulative rainfall) at the location of electric vehicle charging stations can be used as one of the reference feature factors for training the prediction model.

S004: The time series of the charging capacity data is decomposed, and the time series is transformed after noise reduction to obtain the time series of charging capacity data based on the time domain. Since the charging data include time series, and the patterns implied in the waveform changes of the time series are difficult to be detected in the basic form of the primitive data. In an embodiment of this disclosure, the Fast Fourier Transform (FFT) is used to decompose the time series and obtain the basic components such as trend, seasonality and residual in order to dig deeper into the patterns and meanings. The decomposed components can also be considered as smaller predictive tasks for further processing, e.g., the decomposed trend usually follows a linear relation and can be modelled using various linear machine learning models and deep learning models, and the problem of time series prediction can be represented by the Mathematical Equation 7 below:

$$y ( x ) = S ( x ) + T ( x ) + ε \qquad [ Mathematical Equation 7 ]$$

Where, S is seasonality factor, T is trend factor, and ε is prediction error.

Time series data are a series of data observed by time function. The present disclosure uses Fourier transform to decompose time series data because time series data are a combination of data of seasonality, trend and noise, and the variables related to electric vehicle charging, such as weather will show inherent seasonality. As shown in FIG. 6a, the historical temperature data of Palo Alto are analyzed and we can see that the temperature is highest in summer from June to September and lowest in winter from December to January. Due to global warming, the average temperature of each year will rise a little. Since the data including temperature, humidity and the frequency of electric vehicle charging pile failure are discrete time series data, this disclosure obtains the corresponding output by Discrete Fourier Transform, and uses Fourier coefficients to represent the amplitude of each frequency or the intensity of signals. This disclosure uses the Discrete Fourier Transform as shown in Mathematical Equation 8 to obtain the corresponding output of each input and uses the Fourier coefficients to represent the amplitude of each frequency or the intensity of signals. The Discrete Fourier Transform is shown in the Mathematical Equation 8 below:

$${X}_{k} = {\sum }_{n = 0}^{N - 1} {x}_{n} {e}^{- 2 π ikn / N} \qquad [ Mathematical Equation 8 ]$$

Where, x_{1 . . . n} are values of N measurements for a given series, and all possible signal cycles can be obtained and the frequency of signal cycles and the intensity of amplitude can be calculated by x_{1 . . . n}, and x_(1 . . . n) is the N measurements of the given sequence, and all possible signal periods can be obtained and the frequency of signal cycles and the intensity of amplitude can be calculated by x_(1 . . . n) accordingly

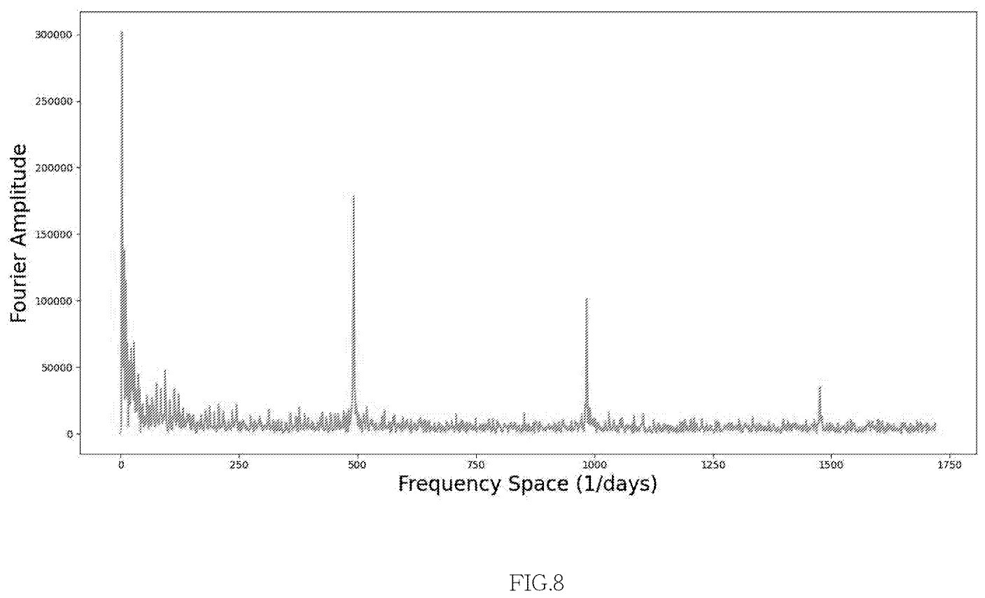

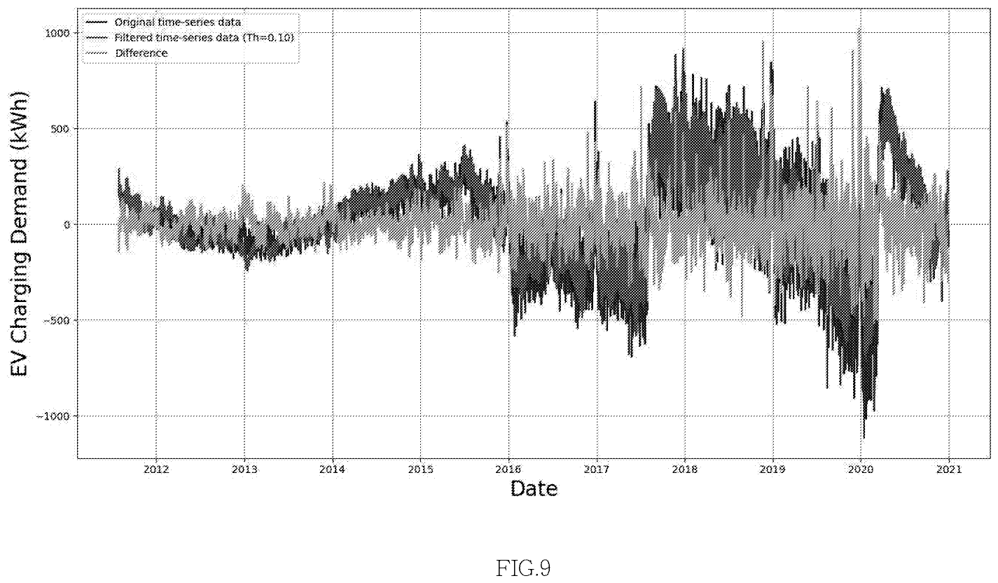

In FIG. 8, the Fourier transformed spectrum of the total daily electric vehicle charging in Palo Alto from July 2011 to December 2020 is shown. In order to eliminate noise data in the time series, a threshold is set to reduce noise. In a specific embodiment, certain multiples of the maximum amplitude (such as 0.8, and 0.9 times) are set to filter out all frequencies that are below the set multiple. In FIG. 9, the time series data of the electric vehicle charging capacity in Palo Alto after filtering noise and when the threshold is set to 0.1 is shown, and correspondingly presents the original time series before filtering the noise, the time series after filtering the noise, and the difference between the above two time series.

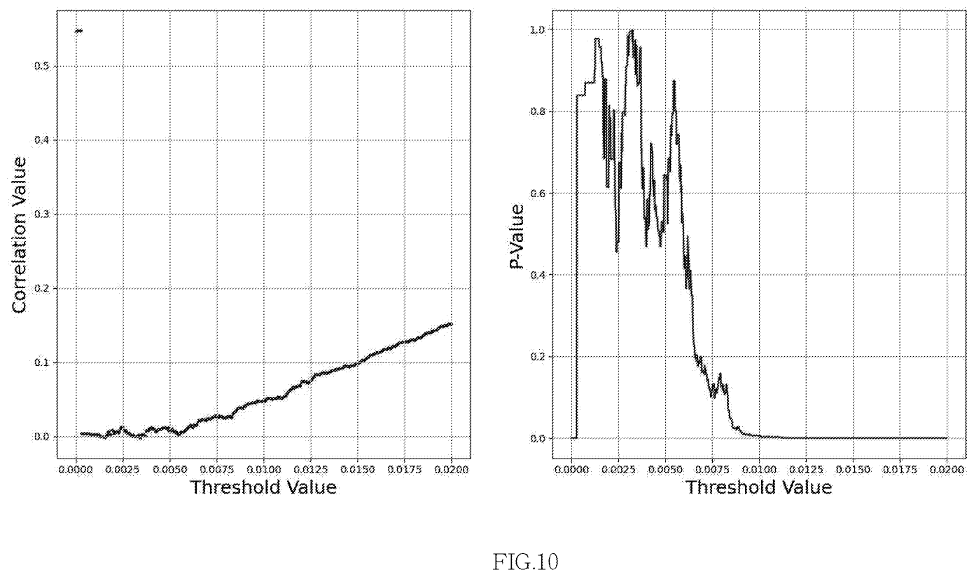

In FIG. 10, the p-values corresponding to different thresholds for eliminating the time series noise of Fourier transformed electric vehicle charging in Palo Alto City. From the observation in FIG. 10, we know that p-value=1 is maximum when the threshold is set to 0.003; therefore, the optimal threshold for eliminating FFT time series noise is 0.003.

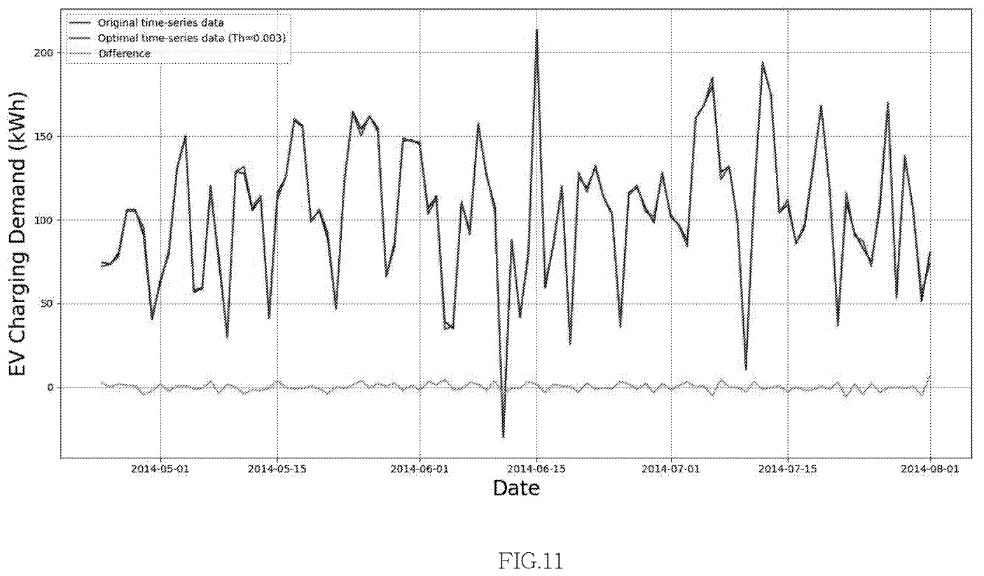

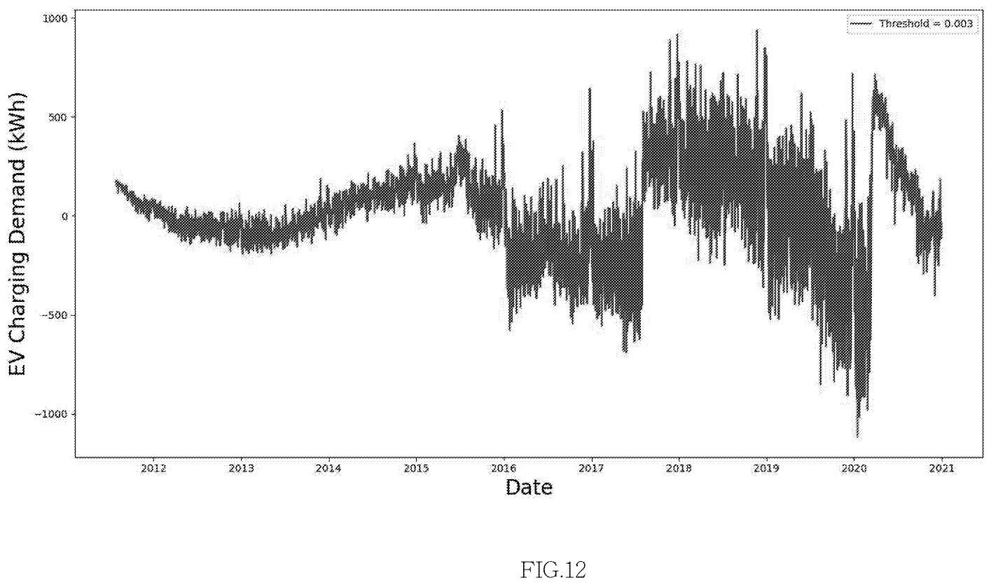

In FIG. 11, the FFT time series data of the daily electric vehicle charging in Palo Alto from April 16 to Jul. 31, 2014 after filtering noise and when the threshold is set to 0.003 are shown, and correspondingly presents the original time series before filtering, the time series after filtering the noise, and the difference between the above two time series. After noise reduction, the FFT series is then processed by Inverse Fourier Transform (IFT) to obtain the electric vehicle charging time series based on time domain with the noise removal. In FIG. 12, the time series of the daily demand for electric vehicle charging in Palo Alto from July 2011 to December 2020 is obtained by Inverse Fourier Transform when the threshold is set to 0.003. The resulting charging time series data will be used as a subsequent predictive target to train the prediction model.

S005: A prediction model is established, the probability value and feature factor are used as reference features, and the charging capacity time series data are used as a predictive target to train the prediction model; S005: building a prediction model, using said probability values and feature factors as reference features, and using charging time series data as a prediction target to train the prediction model;

This disclosure is designated to solve the problem of accurately predicting the demand for electric vehicle charging capacity even in an environment of variable abnormal weather where electric vehicle charging facilities are subject to failure, and thus establishing a Charging Pile Failure and Meteorological Factors-based Framework (CPM Framework) as shown in FIG. 2. In an embodiment, the framework is composed of seven data pipelines, including:
1. Data collection: It includes the collection of charging data of the aforementioned charging facilities and the meteorological data at where the charging facilities are located.
2. Data pre-processing: It includes the cleaning of abnormal values or missing values, and carries out the Exploratory Data Analysis (EDA).
3. Establishment of random failure frequency model of charging data: As mentioned above, the probability of charging facility failure is modelled mainly by Poisson process.
4. Correlation analysis: The correlation analysis is performed by Pearson's correlation test and Spearman's rank correlation test to analyze the feature factors that correlate the meteorological data with the demand for electric vehicle charging.
5. Elimination of noise data in the time series of charging data: Its main purpose is to eliminate the noise in the time series by using Fast Fourier Transform.
6. Establishment of prediction models: These models include multilayer perception (MLP) model, convolutional neural network (CNN) model, recurrent neural network (RNN) model, long short-term memory (LSTM) model, or self-attention based transformer model, and train them to achieve the goals of prediction.
7. Model Performance Analysis: It analyzes the accuracy of prediction of the model through performance indicators.

In this way, the prediction model of the present disclosure can be trained to predict the future charging capacity of the charging facility directly through the prediction model.

To verify the prediction results of the present disclosure and the performance of various types of prediction models, an embodiment of the present disclosure establishes model performance indicators through the python programming language to analyze the performance of the prediction models of this disclosure. In a specific embodiment of this disclosure, five performance indicators, namely Mean Absolute Error (MAE), Mean Square Error (MSE), Root Mean Square Error (RMSE), Mean Absolute Percentage Error (MAPE) and Symmetric Mean Absolute Percentage Error (SMAPE21) are established.

In addition, this disclosure is based on a system framework (CPM Framework) to further train the prediction model to form five enhanced deep neural network prediction models, namely: MLP-CPM, CNN-CPM, RNN-CPM, LSTM-CPM and Transformer-CPM models, and compare the accuracy of the original prediction models (MLP, CNN, RNN, LSTM, and Transformer models), and the comparison results are listed in Table 5 below:

TABLE 5

| | Indicator | | | | |
|---|---|---|---|---|---|
| Prediction model | MAE | MSE | RMSE | MAPE | SMAPE |
| MLP | 273.409 | 73440.419 | 374.244 | 0.391 | 0.355 |
| MLP-CPM | 254.817 | 69180.875 | 345.802 | 0.353 | 0.321 |
| CNN | 207.658 | 61329.811 | 280.93 | 0.34 | 0.258 |
| CNN-CPM | 181.908 | 52375.659 | 245.814 | 0.297 | 0.227 |
| RNN | 183.814 | 48097.197 | 245.938 | 0.292 | 0.242 |
| RNN-CPM | 162.124 | 38429.661 | 193.946 | 0.253 | 0.211 |
| LSTM | 144.508 | 39230.993 | 197.699 | 0.217 | 0.184 |
| LSTM-CPM | 128.612 | 30600.174 | 162.113 | 0.202 | 0.151 |
| Transformer | 127.606 | 29536.244 | 188.09 | 0.187 | 0.145 |
| Transformer-CPM | 116.632 | 21167.342 | 139.375 | 0.148 | 0.110 |

In Table 5, the augmented deep neural network prediction model can further improve the prediction accuracy, for example, the augmented deep neural network prediction model can reduce the MAPE of the MLP model by 9.7%, the MSE of the CNN model by 14.6%, the RMSE of the RNN model by 21.1%, the MSE of the LSTM model by 22.0%, and the MSE of the Transformer model by 28.3%. 22.0% for the LSTM model, and 28.3% for the Transformer model.

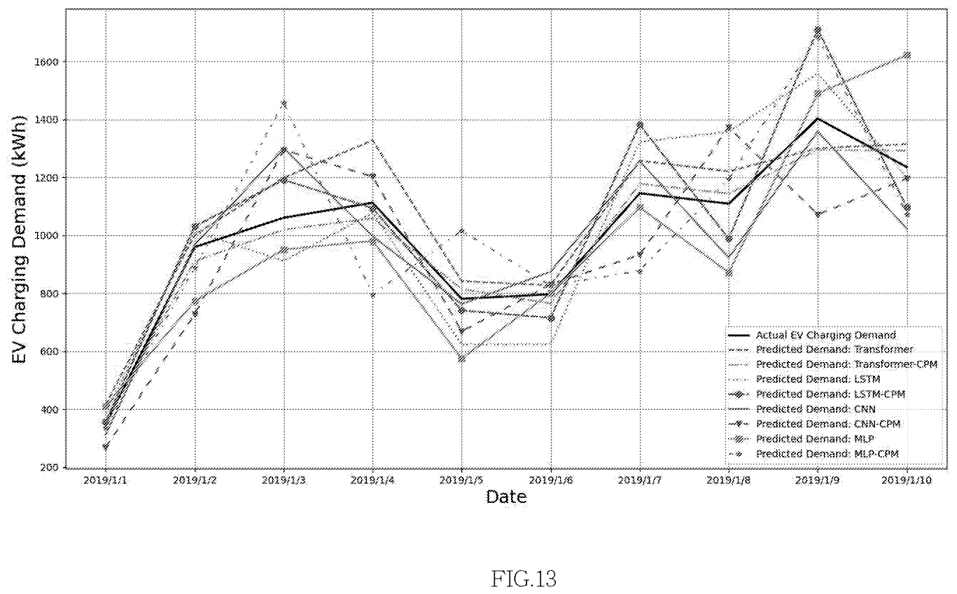

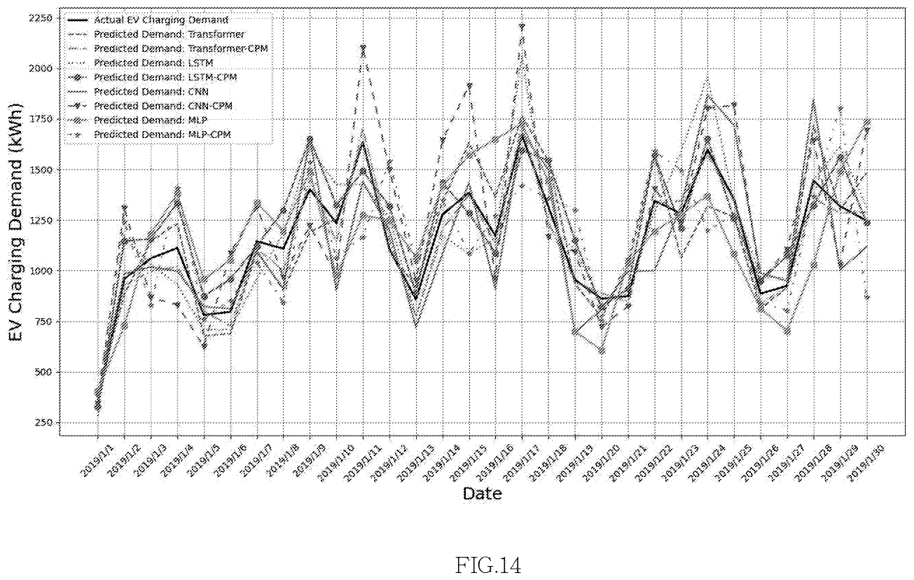

This disclosure further experimentally analyses and compares the accuracy of various models in forecasting the 10-day and 30-day demand for electric vehicle charging. In FIG. 13, the model forecasting the 10-day demand for electric vehicle charging is compared. In FIG. 14, the model forecasting the 30-day demand for electric vehicle charging is compared. The experimental results show that this disclosure can indeed improve the accuracy in forecasting the demand for electric vehicle charging in a complex environment by various prediction models, and has excellent acceptability, feasibility and effectiveness.

In summation of the description above, this disclosure herein effectively overcome the problems of the related art and achieve the expected objectives and effects, and further complies with the patent application requirements, and is submitted to the Patent and Trademark Office for review and granting of the commensurate patent rights.

While the invention has been described by means of specific embodiments, it is to be understood that the disclosure is not limited thereto and numerous equivalent modifications and variations could be made thereto by those skilled in the art without departing from the scope and spirit of the invention set forth in the claims, and the scope of the appended claims should be accorded the broadest interpretation to encompass all such modifications and variations.

What is claimed is:

1. A method of establishing a charging capacity prediction model based on meteorological factors and charging facility failures, loaded by a device to carry out the steps of:
receiving charging capacity data of a charging facility and meteorological data at where the charging facility is located;
extracting a number of random failures based on time from the charging capacity data, and calculating a probability value of the occurrence of a failure by a probability mass function (PMF);
performing a correlation test of the meteorological data and the charging capacity in the charging capacity data to obtain at least one feature factor;
decomposing a time series of the charging capacity data, and performing a transformation to obtain time domain-based charging capacity time series data after reducing noise; and
establishing a prediction model, using the probability value and feature factor as reference features, and using the charging capacity time series data as a predictive target to train the prediction model.

2. The method of establishing a charging capacity prediction model based on meteorological factors and charging facility failures according to claim 1, further comprising the steps of: pre-processing the received charging capacity data and meteorological data, and extracting effective data by an exploratory data analysis.

3. The method of establishing a charging capacity prediction model based on meteorological factors and charging facility failures according to claim 2, wherein the pre-processing comprises the step of cleaning at least one selected from the group consisting of an abnormal value and a missing value.

4. The method of establishing a charging capacity prediction model based on meteorological factors and charging facility failures according to claim 1, wherein the correlation test is at least one selected from the group consisting of Pearson's correlation test and Spearman's rank correlation test.

5. The method of establishing a charging capacity prediction model based on meteorological factors and charging facility failures according to claim 1, wherein the feature factor is a cumulative rainfall based on the charging capacity data.

6. The method of establishing a charging capacity prediction model based on meteorological factors and charging facility failures according to claim 1, wherein a threshold is set for noise reduction after the time series of the charging capacity data are decomposed by Fast Fourier Transform (FFT), and Inverse Fourier Transform of the time series is performed after the noise reduction, to obtain a charging capacity time series data based on time domain.

7. The method of establishing a charging capacity prediction model based on meteorological factors and charging facility failures according to claim 1, wherein the prediction model is a multilayer perception model (MLP), a convolutional neural network (CNN) model, a recurrent neural network (RNN) model, a long short-term memory (LSTM) model, or a self-attention based transformer model.

8. A charging capacity prediction method based on meteorological factors and charging facility failures, comprising the steps of the method of establishing a charging capacity prediction model based on meteorological factors and charging facility failures according to claim 1, and further comprising the steps of predicting a future capacity of the charging facility by the prediction model.

9. A charging capacity prediction system based on meteorological factors and charging facility failures, comprising a processor and at least one storage device, and the storage device storing a system framework that comprises the method of establishing a charging capacity prediction model based on meteorological factors and charging facility failures according to claim 8, and the processor being executed to operate the system framework.
